(19) United States
(12) Patent Application Publication
(10) Pub. No.: US 2023/0174085 A1
(43) Pub. Date: Jun. 8, 2023

(54) DRIVING DIAGNOSIS DEVICE, DRIVING DIAGNOSIS METHOD, AND STORAGE MEDIUM

(71) Applicant: TOYOTA JIDOSHA KABUSHIKI KAISHA, Aichi-ken (JP)

(72) Inventor: Masato ENDO, Nagoya-shi (JP)

(21) Appl. No.: 17/958,434

(22) Filed: Oct. 3, 2022

(30) Foreign Application Priority Data
Dec. 8, 2021 (JP) 2021-199596

(51) Int. Cl. B60W 50/08; G07C 5/04

(52) U.S. Cl. CPC B60W 50/087; G07C 5/04

(57) ABSTRACT

A center server as a driving diagnosis device is configured such that a processor acquires vehicle information of a vehicle, diagnoses driving skill of a driver of the vehicle based on the acquired vehicle information, identifies a driving item for which driving skill has changed driving skill based on reference driving skill and newly diagnosed driving skill, and presents the driving item for which driving skill has changed and the driving skill corresponding to the driving item.

### CROSS-REFERENCE TO RELATED APPLICATION

This application claims priority to Japanese Patent Application No. 2021-199596 filed on Dec. 8, 2021, incorporated herein by reference in its entirety.

### BACKGROUND

### 1. Technical Field

The present disclosure relates to a driving diagnosis device, a driving diagnosis method, and a storage medium for diagnosing driving skill of a driver of a vehicle.

### 2. Description of Related Art

Japanese Unexamined Patent Application Publication No. 2006-232174 (JP 2006-232174 A) discloses a driving support device for a vehicle that determines whether a driver's skill level has improved or decreased when steering assist is performed.

### SUMMARY

Although a device of JP 2006-232174 A has only a steering operation as a skill determination item, there is room for improvement in order to quantitatively show for which driving item the skill of a driver has improved, and for which driving item the skill of the driver has decreased.

The present disclosure provides a driving diagnosis device, a driving diagnosis method, and a storage medium that enable visualization of a driver's driving ability for each driving item.

A driving diagnosis device according to a first aspect of the present disclosure includes a processor. The processor is configured to acquire vehicle information of a vehicle, diagnose driving skill of a driver of the vehicle based on the acquired vehicle information, identify a driving item for which driving skill changes based on reference driving skill and newly diagnosed driving skill, and present the driving item for which driving skill changes and the driving skill corresponding to the driving item.

The driving diagnosis device according to the above configuration performs the driving diagnosis of a driver of the vehicle based on the vehicle information acquired from the vehicle. Specifically, in the driving diagnosis device, the processor diagnoses the driver's driving skill based on the vehicle information, and identifies the driving item for which the driving skill changes based on the reference driving skill and the newly diagnosed driving skill. Then, the processor presents the driving item for which the driving skill changes and the driving skill corresponding to the driving item to the driver and a supervisor of the driver such as the driver's family, the company that manages the vehicle, and the instructor. Thereby, according to the driving diagnosis device, it is possible to visualize the driving ability of the driver for each driving item.

In the first aspect, the processor may identify a driving item for which driving skill changes based on previously diagnosed driving skill and newly diagnosed driving skill.

With the above configuration, it is possible to recognize a change in the driver's driving ability for each driving item by comparing the newly diagnosed driving skill with the previous driving skill.

In the first aspect, the processor may present advice on a driving item for which driving skill decreases.

With the above configuration, it is possible to maintain safe driving by the driver by presenting advice to the driver and/or the supervisor of the driver regarding the decrease in the driving ability.

In the first aspect, the processor may present information indicating a change in driving skill over time for each driving item.

With the above configuration, it is possible to provide a change in the driving ability of the driver for each driving item, thereby providing appropriate advice for safe driving.

In the first aspect, the processor may change an operation threshold of a drive device of the vehicle for a driving item for which driving skill decreases.

With the above configuration, when the driving skill of the driver decreases, the driving of the driver can be assisted on the vehicle side.

In the first aspect, the processor may change a degree of intervention of vehicle control that compensates for a driving item for which driving skill decreases.

With the above configuration, when the driving skill of the driver decreases, the driving of the driver can be assisted on the vehicle side.

The driving diagnosis method according a second aspect of the present disclosure is executed by a computer. The driving diagnosis method comprises acquiring vehicle information of a vehicle, diagnosing driving skill of a driver of the vehicle based on the acquired vehicle information, identifying a driving item for which driving skill changes based on reference driving skill and newly diagnosed driving skill, and presenting the driving item for which driving skill changes and the driving skill corresponding to the driving item.

The driving diagnosis method according to the above configuration performs a driving diagnosis of a driver of the vehicle based on the vehicle information acquired from the vehicle. Specifically, in the driving diagnosis method, the computer diagnoses the driver's driving skill based on the vehicle information, and identifies the driving item for which the driving skill changes based on the reference driving skill and the newly diagnosed driving skill. Then, the computer presents the driving item for which the driving skill changes and the driving skill corresponding to the driving item to, for example, the driver and the above-described supervisor of the driver. Thereby, according to the driving diagnosis method, it is possible to visualize the driving ability of the driver for each driving item.

A storage medium according to a third aspect of the present disclosure stores a program that causes a computer to execute acquiring vehicle information of a vehicle, diagnosing driving skill of a driver of the vehicle based on the acquired vehicle information, identifying a driving item for which driving skill changes based on reference driving skill and newly diagnosed driving skill, and presenting the driving item for which driving skill changes and the driving skill corresponding to the driving item.

The program according to the above configuration performs the driving diagnosis of a driver of the vehicle based on the vehicle information acquired from the vehicle. Specifically, the program diagnoses the driver's driving skill based on the vehicle information, and identifies the driving item for which the driving skill changes based on the reference driving skill and the newly diagnosed driving skill. Then, the program presents the driving item for which the driving skill changes and the driving skill corresponding to the driving item to, for example, the driver and the above-described supervisor of the driver. Thereby, with the program, it is possible to visualize the driving ability of the driver for each driving item.

With each aspect of the present disclosure, it is possible to visualize the driving ability of a driver for each driving item.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a driving diagnosis system according to an embodiment;

FIG. 2 is a block diagram illustrating a hardware configuration of a vehicle of the embodiment;

FIG. 3 is a block diagram illustrating a functional configuration of a vehicle-mounted unit of the embodiment;

FIG. 4 is a block diagram illustrating a hardware configuration of a center server of the embodiment;

FIG. 5 is a block diagram illustrating a functional configuration of the center server of the embodiment;

FIG. 6 is a flowchart illustrating a flow of a diagnostic process executed in the center server of the embodiment;

FIG. 7 is a flowchart illustrating a flow of a setting process executed in the vehicle-mounted unit of the embodiment; and

FIG. 8 is an example of information relating to driving skill displayed on a mobile terminal or an information terminal of the embodiment.

### DETAILED DESCRIPTION OF EMBODIMENTS

A driving diagnosis system including a driving diagnosis device of the present disclosure will be described. The driving diagnosis system is a system that performs a driving diagnosis of a driver of a vehicle and notifies a user of the driving diagnosis result. In addition, the driving diagnosis system changes the settings of an assist function and a safety function in the vehicle driven by the driver according to the driving diagnosis result.

### Overall Configuration

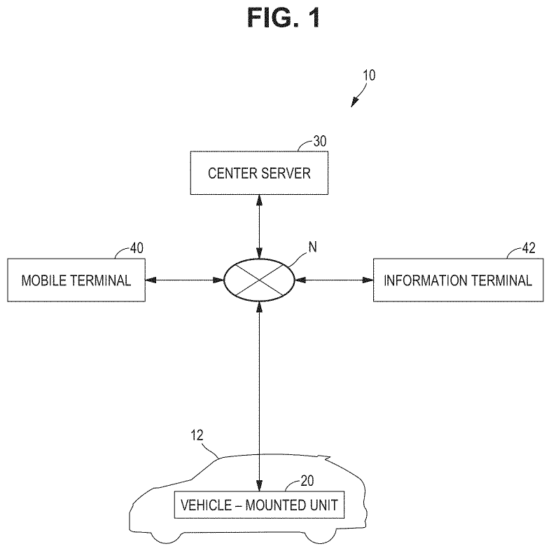

As illustrated in FIG. 1, a driving diagnosis system 10 of an embodiment of the present disclosure includes a vehicle 12, a center server 30 as a driving diagnosis device, a mobile terminal 40, and an information terminal 42. Further, the vehicle 12 is equipped with a vehicle-mounted unit 20. The vehicle-mounted unit 20, the center server 30, the mobile terminal 40, and the information terminal 42 are connected to each other through a network N. Although FIG. 1 illustrates one vehicle 12, one vehicle-mounted unit 20, one mobile terminal 40, and one information terminal 42 for one center server 30, the number of the vehicle 12, the vehicle-mounted unit 20, the mobile terminal 40, and the information terminal 42 is not limited thereto.

The center server 30 is installed in, for example, a manufacturer that manufactures the vehicle 12 or a company operated by the manufacturer. The mobile terminal 40 is exemplified by a smartphone owned by the driver of the vehicle 12, the driver's family, or an owner of the vehicle 12. The information terminal 42 is exemplified by a personal computer installed for an administrator who manages the vehicle 12 when the vehicle 12 is a taxi or a transportation vehicle.

### Vehicle

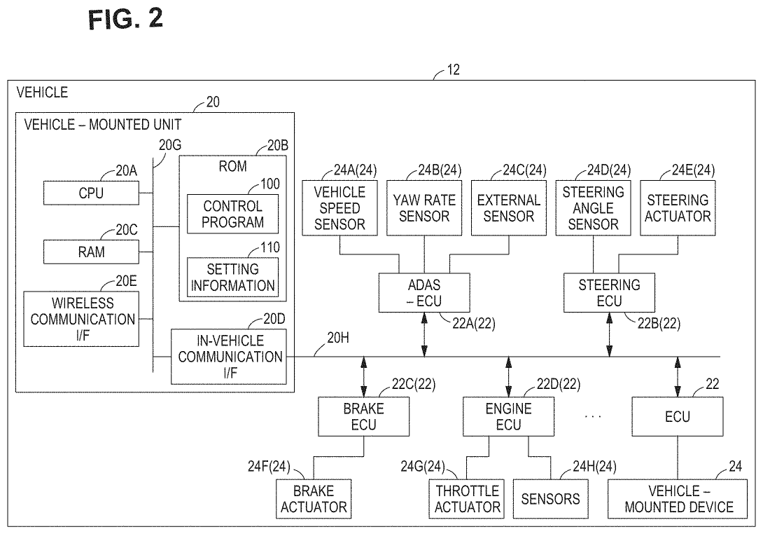

As illustrated in FIG. 2, the vehicle 12 according to the present embodiment is configured to include the vehicle-mounted unit 20, a plurality of electronic control units (ECUs) 22, and a plurality of vehicle-mounted devices 24.

The vehicle-mounted device 20 includes a central processing unit (CPU) 20A, a read-only memory (ROM) 20B, a random access memory (RAM) 20C, an in-vehicle communication I/F (Interface) 20D, and a wireless communication I/F 20E. The CPU 20A, the ROM 20B, the RAM 20C, the in-vehicle communication I/F 20D, and the wireless communication I/F 20E are connected to each other so as to be communicable with each other via an internal bus 20G.

The CPU 20A is a central arithmetic processing unit that executes various programs and controls each unit. That is, the CPU 20A reads the program from the ROM 20B and executes the program using the RAM 20C as a work area.

The ROM 20B stores various programs and various data. The ROM 20B of the present embodiment stores a control program 100 that collects vehicle information related to the state and control of the vehicle 12 from the ECU 22 and sets the assist function and the safety function of the vehicle 12. Along with the execution of the control program 100, the vehicle-mounted device 20 executes each process including a setting process described below. Further, the ROM 20B stores setting information 110 related to the vehicle control setting of the vehicle 12, which will be described below.

The RAM 20C temporarily stores a program or data as a work area. The in-vehicle communication I/F 20D is an interface for connecting to each ECU 22. For the interface, a communication standard based on a CAN protocol is used. The in-vehicle communication I/F 20D is connected to an external bus 20H.

The wireless communication I/F 20E is a wireless communication module for communicating with the center server 30. For the wireless communication module, communication standards such as 5G, LTE, and Wi-Fi (registered trademark) are used. The wireless communication I/F 20E is connected to the network N.

The ECU 22 includes at least an advanced driver assistance system (ADAS)-ECU 22A, a steering ECU 22B, a brake ECU 22C, and an engine ECU 22D.

The ADAS-ECU 22A controls the advanced driver assistance system in an integrated manner. A vehicle speed sensor 24A, a yaw rate sensor 24B, and an external sensor 24C forming the vehicle-mounted device 24 are connected to the ADAS-ECU 22A. The external sensor 24C is a group of sensors used for detecting the surrounding environment of the vehicle 12. The external sensor 24C includes, for example, a camera that images the surroundings of the vehicle 12, a millimeter-wave radar that transmits exploration waves and receives reflected waves, and a laser imaging detection and ranging (LIDAR) that scans the front of the vehicle 12.

The steering ECU 22B controls power steering. A steering angle sensor 24D and a steering actuator 24E forming the vehicle-mounted device 24 are connected to the steering ECU 22B. The steering angle sensor 24D is a sensor that detects the steering angle of the steering wheel. The steering actuator 24E is a drive device that steers a steered wheel of the vehicle 12 in place of the operation of the driver or by intervening in the operation of the driver.

The brake ECU 22C controls the brake system of the vehicle 12. A brake actuator 24F forming the vehicle-mounted device 24 is connected to the brake ECU 22C. The brake actuator 24F is a drive device that operates the brakes of the vehicle 12 in place of the operation of the driver or by intervening in the operation of the driver.

The engine ECU 22D controls the engine of the vehicle 12. A throttle actuator 24G and sensors 24H forming the vehicle-mounted device 24 are connected to the engine ECU 22D. The throttle actuator 24G is a drive device that operates the throttle of the vehicle 12 in place of the operation of the driver or by intervening in the operation of the driver. The sensors 24H include an oil temperature sensor for measuring the oil temperature of the engine oil, an oil pressure sensor for measuring the oil pressure of the engine oil, and a rotation sensor for detecting the rotation speed of the engine.

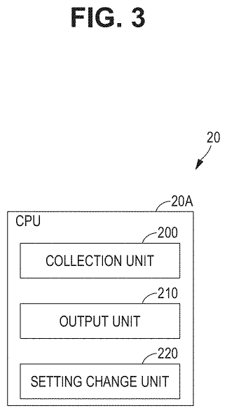

As illustrated in FIG. 3, in the vehicle-mounted device 20 of the present embodiment, the CPU 20A functions as a collection unit 200, an output unit 210, and a setting change unit 220 by executing the control program 100.

The collection unit 200 has a function of acquiring vehicle information related to the state of the vehicle-mounted device 24 from each ECU 22 of the vehicle 12 and the state of the vehicle 12 obtained from the vehicle-mounted device 24. The vehicle information includes information such as the vehicle speed, the acceleration, the yaw rate, the steering angle, the accelerator opening degree, the brake pedal depression force, or the stroke. Further, the vehicle information may include an image of the outside of the vehicle 12 which is captured by a camera as the external sensor 24C.

The output unit 210 has a function of outputting the vehicle information collected by the collection unit 200 to the center server 30.

The setting change unit 220 has a function of changing the vehicle control setting in the vehicle 12 based on the setting information acquired from the center server 30. In the vehicle control setting, the setting of whether the assist function and the safety function are operated, the operation threshold, and the degree of intervention for the driver's driving are provided as setting items, and these setting items can be changed based on the setting information. Here, examples of the assist function include brake assist, adaptive cruise control, and lane keep assist. Further, examples of the safety function include vehicle stability control (VSC), a traction control system (TRC), and an erroneous step suppression system.

### Center Server

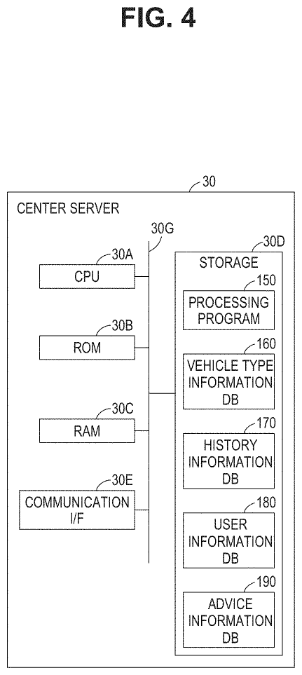

As illustrated in FIG. 4, the center server 30 includes a CPU 30A, a ROM 30B, a RAM 30C, a storage 30D, and a communication I/F 30E. The CPU 30A, the

ROM 30B, the RAM 30C, the storage 30D, and the communication I/F 30E are connected to each other so as to be communicable with each other via an internal bus 30G. The functions of the CPU 30A, the ROM 30B, the RAM 30C, and the communication I/F 30E are the same as those of the CPU 20A, the ROM 20B, the RAM 20C, and the wireless communication I/F 20E of the vehicle-mounted device 20. The communication I/F 30E may perform wired communication.

The storage 30D as a memory is composed of a hard disk drive (HDD) or a solid state drive (SSD), and stores various programs and various data. The storage 30D of the present embodiment stores a processing program 150, a vehicle type information database (DB) 160, a history information DB 170, a user information DB 180, and an advice information DB 190. The ROM 30B may store the processing program 150, the vehicle type information DB 160, the history information DB 170, the user information DB 180, and the advice information DB 190.

The processing program 150 is a program for controlling the center server 30. With the execution of the processing program 150, the center server 30 executes each process including a diagnostic process for diagnosing the driving skill of the driver of the vehicle 12.

The vehicle type information DB 160 is a database in which information such as functions, equipment, and specifications for each vehicle type is stored.

The history information DB 170 stores the history of the driving diagnosis results of each driver registered in the center server 30.

The user information DB 180 stores information such as the age, gender, and driving history of the driver who is the target of the driving diagnosis, and information about a user's contact point for the notification of the driving diagnosis result.

The advice information DB 190 stores information on advice according to the driving diagnosis result. For example, advice information is provided to advise the driver to increase the inter-vehicle distance in response to a case where the driving diagnosis result shows a tendency for the time of applying the brakes of the vehicle 12 to be delayed. The advice information can include not only text data related to the advice but also image information and voice information.

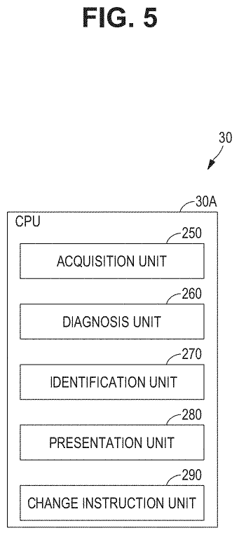

As illustrated in FIG. 5, in the center server 30 of the present embodiment, the CPU 30A functions as an acquisition unit 250, a diagnosis unit 260, an identification unit 270, a presentation unit 280, and a change instruction unit 290 by executing the processing program 150.

The acquisition unit 250 has a function of acquiring vehicle information of the vehicle 12 from the vehicle-mounted device 20 of the vehicle 12. The acquisition unit 250 acquires the vehicle information transmitted from the vehicle-mounted device 20 at a predetermined time.

The diagnosis unit 260 has a function of diagnosing the driving skill of the driver of the vehicle 12 based on the vehicle information acquired by the acquisition unit 250. The diagnosis unit 260 generates a score for each driving item as driving skill. The driving items include items related to the driver's operation itself such as a steering operation, a brake operation, and an accelerator operation, and items related to the driver's driving feeling such as weaving between lanes, an inter-vehicle distance from the vehicle ahead, acceleration and deceleration. The score is calculated as a number in the range of 0 to 100. Further, instead of the score, a level divided into a plurality of stages may be generated.

The identification unit 270 has a function of identifying a driving item for which the driving skill has changed. Specifically, the identification unit 270 identifies a driving item for which the driving skill has changed based on the reference driving skill and the driving skill newly diagnosed by the diagnosis unit 260. In the present embodiment, when identifying a driving item for which the driving skill has changed of a certain driver, the identification unit 270 uses the previously diagnosed driving skill of the driver as the “reference driving skill”. However, the reference driving skill is not limited thereto, and as the “reference driving skill”, driving skill set in advance as a comparison target and average driving skill among drivers of the same generation may be used.

The presentation unit 280 has a function of presenting a driving item for which the driving skill has changed and the driving skill corresponding to the driving item.

Specifically, the presentation unit 280 transmits information related to the driving skill to the mobile terminal 40 or the information terminal 42 of the user. The user includes not only the driver but also the driver's family, the company that manages the vehicle 12, and a supervisor of the driver such as an instructor.

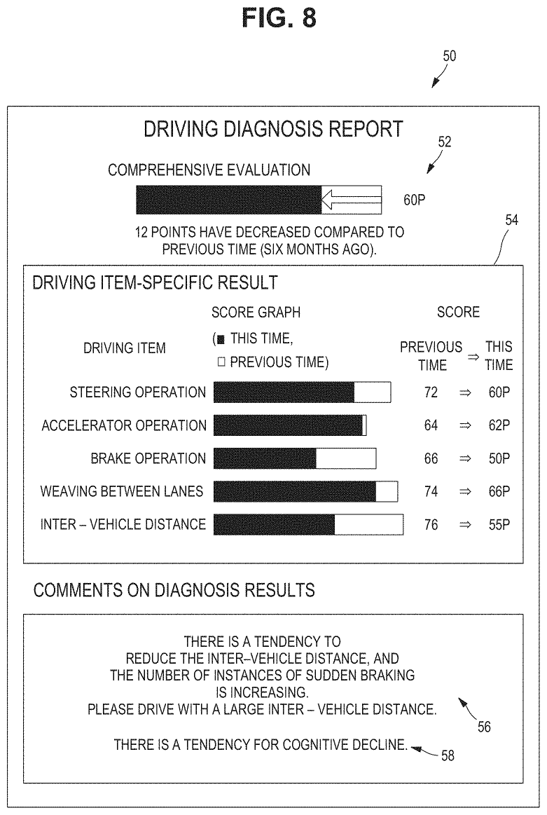

In addition, the presentation unit 280 can present advice regarding driving items for which driving skill has decreased (see FIG. 8). Further, the presentation unit 280 can present an image showing a change in driving skill over time for each driving item (see FIG. 8).

The change instruction unit 290 has a function of changing the setting of the assist function and the safety function of the vehicle 12. The settings of the assist function and the safety function are changed by changing the operation thresholds of the steering actuator 24E, the brake actuator 24F, the throttle actuator 24G, and the like, which are the drive devices. The change instruction unit 290 of the present embodiment changes the operation thresholds related to the assist function and the safety function of the vehicle 12. The functions are related to the driving item for which the driving skill has changed.

In addition, the degree of intervention in vehicle control can be changed by changing the setting of whether the assist function and the safety function are operated. The change instruction unit 290 of the present embodiment changes the setting of whether the assist function and the safety function are operated in order to compensate for the driving item for which driving skill has decreased.

### Control Flow

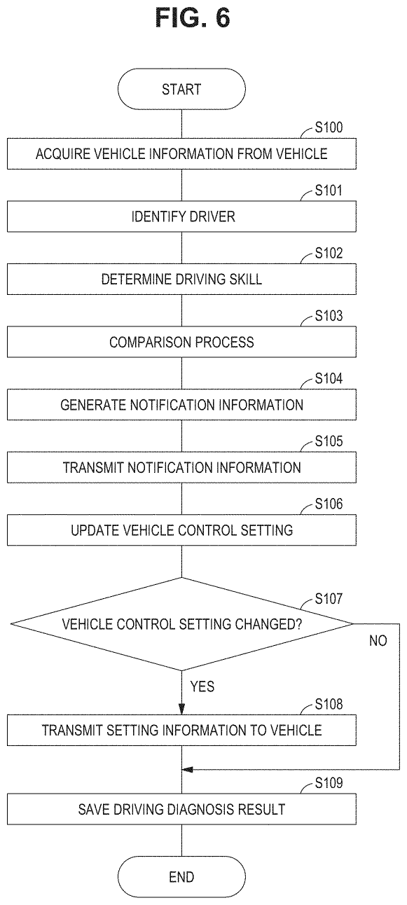

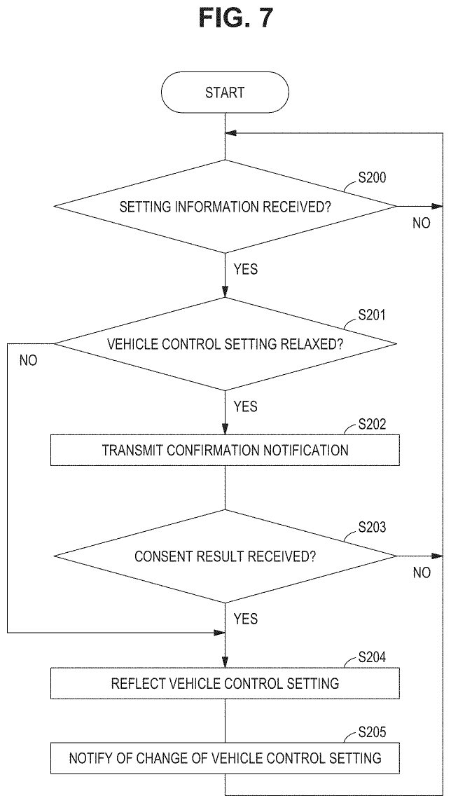

The flow of a process as a driving diagnosis method executed by the driving diagnosis system 10 of the present embodiment will be described with reference to the flowcharts of FIGS. 6 and 7. The process in the vehicle-mounted device 20 is executed by the CPU 20A of the vehicle-mounted device 20 functioning as the collection unit 200, the output unit 210, and the setting change unit 220. Further, the process in the center server 30 is executed by the CPU 30A of the center server 30 functioning as the acquisition unit 250, the diagnosis unit 260, the identification unit 270, the presentation unit 280, and the change instruction unit 290.

First, the details of the diagnostic process in the center server 30 will be described. In step S100 of FIG. 6, the CPU 30A acquires the vehicle information transmitted from the vehicle 12, that is, the vehicle-mounted device 20.

In step S101, the CPU 30A identifies the driver. Specifically, the CPU 30A identifies the driver based on the driver information transmitted from the vehicle-mounted device 20 together with the vehicle information. In the same step, the CPU 30A may identify the driver from a driving tendency analyzed based on the vehicle information.

In step S102, the CPU 30A executes the driving skill determination. Specifically, the CPU 30A calculates the driving skill of the driver after collecting the vehicle information for each vehicle type based on the vehicle type information DB 160.

In step S103, the CPU 30A executes the comparison process. Specifically, the CPU 30A compares the previous driving skill of the driver with the driving skill calculated in step S102 for each driving item. As a result, the driving item for which the driving skill has changed is identified. When a difference between the current and previous driving skill scores is equal to or less than a predetermined value, it is assumed that the driving skill has not changed, whereas when the difference between the scores exceeds the predetermined value, the comparison process may be performed assuming that the driving skill has changed.

In step S104, the CPU 30A generates notification information. Specifically, the CPU 30A generates, as notification information, at least a driving item for which driving skill has decreased, a driving skill for the driving item, and the content of advice acquired from the advice information DB 190.

In step S105, the CPU 30A transmits the notification information to a user. The CPU 30A transmits the notification information which is acquired from the user information DB 180 to the mobile terminal 40 and/or the information terminal 42 of the user. As a result, a driving diagnosis report 50 as illustrated in FIG. 8 is displayed on the screen of the mobile terminal 40 or the information terminal 42.

In step S106, the CPU 30A updates the vehicle control settings applied to the vehicle 12. Thereby, the CPU 30A can change at least one of the setting of whether the assist function and the safety function are operated and the operation threshold of these functions.

In step S107, the CPU 30A determines whether the vehicle control setting in the vehicle 12 has been changed. When the CPU 30A determines that the vehicle control setting has been changed (YES in step S107), the process proceeds to step S108. On the other hand, when the CPU 30A determines that the vehicle control setting has not been changed (NO in step S107), the process proceeds to step S109.

In step S108, the CPU 30A transmits the setting information to the vehicle 12. Specifically, the CPU 30A transmits the setting information corresponding to the updated vehicle control setting to the vehicle-mounted device 20 of the vehicle 12.

In step S109, the CPU 30A saves the driving diagnosis result. The CPU 30A stores the data related to the driving skill for each driving item, which is the driving diagnosis result, in the history information DB 170. Then, the CPU 30A ends the diagnostic process.

Next, the details of the setting process in the vehicle-mounted device 20 will be described.

In step S200 of FIG. 7, the CPU 20A determines whether setting information has been received. When the CPU 20A determines that the setting information has been received (YES in step S200), the process proceeds to step S201. On the other hand, when it is determined that the CPU 20A has not received the setting information (NO in step S200), step S200 is repeated.

In step S201, the CPU 20A determines whether the vehicle control setting is relaxed. When the CPU 20A determines that the vehicle control setting is relaxed (YES in step S201), the process proceeds to step S202. On the other hand, when the CPU 20A determines that the vehicle control setting is not relaxed (NO in step S201), the process proceeds to step S204.

In step S202, the CPU 20A transmits a confirmation notification to the driver's supervisor. Specifically, the CPU 20A transmits, to at least one of the mobile terminal 40 and the information terminal 42 of the supervisor, a notification to confirm with the driver's supervisor that the assist function and safety function will be stopped and the operation threshold will be relaxed.

In step S203, the CPU 20A determines whether a consent result has been received. The consent result is a notification indicating that the driver's supervisor has consented to stop the operation of the assist function and the safety function and relax the operation threshold, and the consent result is returned from the mobile terminal 40 or the information terminal 42 to which the confirmation notice is transmitted. When the CPU 20A determines that the consent result has been received (YES in step S203), the process proceeds to step S204. On the other hand, when the CPU 20A determines that the consent result has not been received (NO in step S203), the process returns to step S200.

In step S204, the CPU 20A reflects the relaxed setting in the vehicle control setting. Specifically, the CPU 20A changes the operation stoppage of the assist function and safety function and the operation threshold, which are the targets to be changed.

In step S205, the CPU 20A notifies the driver's supervisor that the change of the vehicle control setting is completed. Specifically, the CPU 20A transmits, to the mobile terminal 40 or the information terminal 42 of the driver's supervisor, information to the effect that the settings of the assist function and the safety function have been changed. In addition, a meter display of the vehicle 12 is displayed to indicate that the settings of the assist function and the safety function have been changed. Then, the process returns to step S200.

### Summary

The center server 30 as the driving diagnosis device of the present embodiment performs the driving diagnosis of the driver of the vehicle 12 based on the vehicle information acquired from the vehicle 12. Specifically, in the center server 30, the CPU 30A diagnoses the driving skill of the driver based on the vehicle information, and identifies the driving item for which the driving skill has changed based on the reference driving skill and the newly diagnosed driving skill. Then, the CPU 30A presents a driving item for which the driving skill has changed and the driving skill corresponding to the driving item to, for example, a driver and a supervisor of the driver. Thereby, according to the present embodiment, it is possible to visualize the driving ability of the driver for each driving item.

In particular, in the center server 30 of the present embodiment, the driving item for which the driving skill has changed is identified based on the previously diagnosed driving skill and the newly diagnosed driving skill. Therefore, with the present embodiment, it is possible to recognize a change in the driver's driving ability for each driving item of the driver by comparing the newly diagnosed driving skill with the previous driving skill.

Further, with the present embodiment, changes in driving skill over time are shown for each driving item. For example, as illustrated in FIG. 8, when the driving diagnosis report 50 is displayed on the screen of the mobile terminal 40 or the information terminal 42 as the driving diagnosis result, in addition to a comprehensive evaluation 52 that takes into account all the driving items, a driving item-specific result 54 that summarizes the scores for each driving item is displayed. The driving item-specific result 54 provides a change in driving skill over time by showing a change in a newly calculated score from the previous time (for example, six months ago). That is, in the present embodiment, it is possible to provide a change in the driving ability of the driver for each driving item, thereby providing appropriate advice (for example, advice 56 in FIG. 8) for safe driving.

Further, in the center server 30 of the present embodiment, the CPU 30A presents advice regarding a driving item for which driving skill has decreased. In the example of FIG. 8, the advice 56 for increasing the inter-vehicle distance is provided in response to a decrease in driving skill related to the driving item of the inter-vehicle distance. Therefore, according to the present embodiment, by presenting advice to the driver regarding the decrease in driving ability, or by presenting the advice to the driver's supervisor and giving advice from the supervisor to the driver, it is possible to maintain the safe driving of the vehicle 12. As illustrated in FIG. 8, by presenting a comment 58 related to the event (for example, decrease in cognitive ability) that can be read from the decrease in driving skill and the advice 56 on the decrease in driving skill in terms of the inter-vehicle distance to the supervisor, it is possible to provide the supervisor with the diagnosed cause of the decrease in the driving ability of the driver.

Further, the center server 30 of the present embodiment changes the operation threshold of the drive device of the vehicle 12 related to the driving item for which driving skill has decreased, or changes the degree of intervention of the vehicle control that supplements the driving item for which driving skill has decreased.

Therefore, with the present embodiment, it is possible to assist the driver's driving on the vehicle 12 side when the driving skill of the driver has decreased.

### Notes

In the embodiment described above, the center server 30 is used as the driving diagnosis device, but the present disclosure is not limited thereto, and the vehicle-mounted device 20 may be used as the driving diagnosis device. In this case, the vehicle-mounted device 20 collects vehicle information of the vehicle 12 on which the vehicle-mounted device 20 is mounted, executes the diagnostic process, and executes the setting process.

In addition, various processors other than the CPU may execute the various processes executed by the CPU 20A and the CPU 30A by reading software (a program) in the above embodiment. Examples of a processor in this case include a programmable logic device (PLD), such as a field-programmable gate array (FPGA), in which the circuit configuration can be changed after manufacture, and a dedicated electric circuit, such as an application specific integrated circuit (ASIC), which is a processor having a circuit configuration specially designed for executing a specific process. Further, each of the above-described processes may be executed by one of these various processors, or may be executed by a combination (for example, a plurality of FPGAs, a combination of a CPU and an FPGA, or the like) of two or more processors of the same type or different types. Further, the hardware-like structure of these various processors is, more specifically, an electric circuit in which circuit elements such as semiconductor elements are combined.

Further, in the embodiment described above, each program has been described in a form in which each program is stored (installed) in a non-transitory recording medium readable by a computer in advance. For example, the control program 100 in the vehicle-mounted device 20 is stored in the ROM 20B in advance, and the processing program 150 in the center server 30 is stored in the storage 30D in advance. However, the present disclosure is not limited thereto, and each program may be provided in a form recorded on a non-transitory recording medium such as a compact disc read-only memory (CD-ROM), a digital versatile disc read-only memory (DVD-ROM), and a universal serial bus (USB) memory. Further, the program may be downloaded from an external device via the network.

The processing flow described in the above embodiment is an example, and unnecessary steps may be deleted, new steps may be added, or the processing order may be changed without departing from the scope of the disclosure.

What is claimed is:

1. A driving diagnosis device comprising a processor, wherein the processor is configured to:
acquire vehicle information of a vehicle;
diagnose driving skill of a driver of the vehicle based on the acquired vehicle information;
identify a driving item for which driving skill changes based on reference driving skill and newly diagnosed driving skill; and
present the driving item for which driving skill changes and the driving skill corresponding to the driving item.

2. The driving diagnosis device according to claim 1, wherein the processor is configured to identify a driving item for which driving skill changes based on previously diagnosed driving skill and newly diagnosed driving skill.

3. The driving diagnosis device according to claim 1, wherein the processor is configured to present advice on a driving item for which driving skill decreases.

4. The driving diagnosis device according to claim 1, wherein the processor is configured to present information indicating a change in driving skill over time for each driving item.

5. The driving diagnosis device according to claim 1, wherein the processor is configured to change an operation threshold of a drive device of the vehicle for a driving item for which driving skill decreases.

6. The driving diagnosis device according to claim 1, wherein the processor is configured to change a degree of intervention of vehicle control that compensates for a driving item for which driving skill decreases.

7. A driving diagnosis method executed by a computer, the driving diagnosis method comprising:
acquiring vehicle information of a vehicle;
diagnosing driving skill of a driver of the vehicle based on the acquired vehicle information;
identifying a driving item for which driving skill changes based on reference driving skill and newly diagnosed driving skill; and
presenting the driving item for which driving skill changes and the driving skill corresponding to the driving item.

8. A non-transitory storage medium storing a program that causes a computer to execute:
acquiring vehicle information of a vehicle;
diagnosing driving skill of a driver of the vehicle based on the acquired vehicle information;
identifying a driving item for which driving skill changes based on reference driving skill and newly diagnosed driving skill; and
presenting the driving item for which driving skill changes and the driving skill corresponding to the driving item.
